(19) United States
(12) Patent Application Publication
(10) Pub. No.: US 2024/0370040 A1
(43) Pub. Date: Nov. 7, 2024

(54) SELF-LEARNING COMMAND & CONTROL MODULE FOR NAVIGATION (GENISYS) AND SYSTEM THEREOF

(71) Applicant: SAGAR DEFENCE ENGINEERING PRIVATE LIMITED, Mumbai (IN)

(72) Inventors: Nikunj Parashar, Mumbai (IN); Mridul Babbar, Mumbai (IN); Lakshay Dang, Mumbai (IN); Saurabh Patil, Mumbai (IN); Akshay Sharma, Mumbai (IN); Shilpa Parashar, Mumbai (IN)

(21) Appl. No.: 18/655,547

(22) Filed: May 6, 2024

(30) Foreign Application Priority Data
Jul. 27, 2022 (IN) 202221024830

(51) Int. Cl. G05D 1/87; G05D 1/243; G05D 1/248; G05D 1/46; G05D 1/622; G05D 101/15; G05D 109/10; G05D 109/20; G05D 109/30

(52) U.S. Cl. CPC G05D 1/87; G05D 1/2435; G05D 1/248; G05D 1/46; G05D 1/622; G05D 2101/15; G05D 2109/10; G05D 2109/20; G05D 2109/30

(57) ABSTRACT

Navigation system (300) for land, air, marine or submarine vehicle (302), comprising a remote control workstation (301) with Manual control mode (310), Mission Planning mode (330) and tactical control mode (360) initiating command-and-control options; a navigation module (100) retrofittably disposed on the vehicle (302); a plurality of perception sensors (318) disposed on the vehicle (302); the system (300) receives manual, electrical, radio and audio commands of human operator (305) in the manual control (310) and mission planning mode (330) and converts them to dataset for training a navigation model having a navigational algorithm. The perception sensors (318) generate dataset for self-learning in real time in manual control mode (310), mission control mode (330) and tactical control mode (360); the navigational system (300) autonomously navigates with presence of communication network (390) and in absence of communication network (390).

### CLAIM OF PRIORITY

The present invention takes priority from Indian patent application titled “Self-Learning Command and Control Module (GENISYS)”, application number: 202221024830 post-dated to 27 Jul. 2022.

### FIELD OF INVENTION

The present invention relates to control and manage maneuver of a vehicle. Particularly, the present invention pertains to maneuver control and management of a ground, marine or aviation vehicle. More particularly, the present invention relates to maneuver control and management in situations of loss of communication from a base station of the vehicle.

### BACKGROUND OF THE INVENTION

Ground, marine as well as aviation vehicles are known to be manned as well as unmanned. Routes and enroute unknowns of such vehicles are predictable as well as unpredictable.

Unmanned vehicles are controlled by sensors and communication. CN3067575 discloses self-learning autonomous navigation particularly for unmanned underwater vehicle based on an improved recurrent neutral network. CN109521454 discloses navigation method based on cubature Kalman filter. CN102778237 provides a map self-learning system in vehicle navigation, wherein the self-learning function of an electronic navigation map in a vehicle navigation system is achieved by curve fitting and a prediction algorithm, so that the vehicle positioning precision is enhanced and the electronic navigation map is perfected.

There are challenges for vehicles which are manned at times but unmanned in different situations. Such challenges become complex when communication breaks down!

The present invention attempts to bridge this significant industrial requirement.

### OBJECT OF THE INVENTION

It is an object of the present invention to invent a device and method thereof that captures discrete instructions under operation with operator on-board and integrates such instructions as self-learning.

It is another object of the present invention to invent a device and method thereof that captures instructions under operation by remote operator and integrates such instructions as self-learning.

It is yet another object of the present invention to invent a device and method thereof that captures macro as well as micro instructions by operators, while on-board as well as remotely and integrate such instructions as self-learning.

It is yet another object of the present invention to invent a device that is retro-fittable in any vehicle to make such vehicle suitable for autonomous operation, particularly in absence of communication network.

### SUMMARY OF THE INVENTION

The present invention is a navigation system having a navigation module, named GENISYS, that is retro-fittable in any manned or unmanned road/aviation/marine/submarine vehicle. GENISYS has the capability to capture all operator instructions and commands including audio, manual, electrical, radio commands and convert them into an executable data/algorithm with time and position co-ordinates. GENISYS is connected, by hard wiring or wirelessly, with plurality of sensors and intelligence of the vehicle. GENISYS integrates intrinsic capabilities of the vehicle with executable data and algorithms developed from operator instructions and commands.

A drone, hereinafter termed as a platform or a vehicle, disposed with the navigation module is capable of self-navigating to an obstructed unknown destination or an obstructed unknown target even in absence of any communication network while an obstruction hinders a direct view of the target. In the description below, the inventive hardware and software of the navigation module and the navigation system is described step by step resulting into such capability.

A navigation system around the vehicle comprises:
Remote Control Workstation or RCW
Navigation module or GENISYS including Command and Control unit and
A plurality of perception sensors

Three types of controls deployed for the navigation module are
1. Manual Control
2. Mission Planning
3. Tactical Control

Manual control implies direct human control including throttle and steering control, either by being physically present in the tactical platform of vehicle particularly when the vehicle is road worthy vehicle or an airplane or a human carrying drone or a ship or a marine or a submarine; or remotely. In the mission planning type of control, before operation initialization, complete planning is executed. This planning includes how the vehicle should perform, in which scenario how it must behave, and all if-else this that or if commands and controlling factors are preplanned and fed to the RCW system. Data from multiple sensors is taken and graphed or shown or processes or used to generate user interface to perform the multiple jobs like control/monitor/eject/disturb/explode with the help of system/vehicle/platform. Tactical control includes wider guidance navigation and controlling system including handshaking with mission planning for decision-making in critical scenarios including scenarios like obstacle avoidance and reactive guidance, including multiple inputs and outputs. It maps the system with actual trajectory with desired trajectory. The difference is calculated and offset is fed to the system for learning, which helps system to progressively better match the actual trajectory with the desired trajectory.

Command Control Unit (CCU) comprises Self Learning Command Control Unit, Unmanned Control and Assessment & Correction platform. Manual Control controls the rudder and throttle of the engine directly without autonomous operation. The vehicle control gives the signal to VDC (Vehicle Direct Control) which manages all the controlling of the vehicle. Here, mixed signal type controlling operates where Command Control Unit processes the data, and it is carried forward to Vehicle Direct Control. Self-Learning Command Control Unit consists of sub-systems including Vehicle Guidance and Course Control.

Unmanned Control primarily relies on a plurality of perception sensors whose data is processed, assessed for precision and provides reactive guidance to mission planning.

With respect to autonomous maritime platforms, tactical platforms enable to exercise various mission sets such as sea denial, escort, survey, logistics, targeted counter abilities, etc. As such, such a platform will conduct assets planning by Mission Objectives, Data Collection and Analysis, Asset Availability and Capabilities, Optimization Algorithms, Resource Allocation, Dynamic Adaptation, and Communication and Coordination. By combining data analysis, optimization algorithms, and adaptive planning strategies, an autonomous maritime tactical platform can efficiently conduct assets planning for autonomous sea-going vessels. It optimizes the utilization of assets, enhances mission performance, and enables effective decision-making in dynamic maritime environments. Assessment and Correction Platform implements corrective measures and action taken to ensure that the tactical platform fulfills its objectives.

A plurality of perception sensors connected to the reactive guidance system include Accelerometer, Gyroscope, Compass, Magnetic Heading Sensor, Barometric Sensor, Multiple GNSS, Vision Sensor including camera, stereo camera, Omni camera, IR camera, Ultra-sonic sensor, Laser Range finder, Li-Dar, Sonar, Radar, Optical sensor, Depth sensor. Such type of sensor data using sensor fusion algorithms gives appropriate data. It is referred to as a computational methodology that aims at combining measurement from multiple sensors such that they jointly give more precise information on the measured system than any of the sensors alone.

The data from such sensor and data from human operator or third-party user or device helps to perform the critical tasks at Remote Control Workstation (RCW) with human operator in-loop. This data is used to course controlling of the platform or vehicle. Course control includes multiple movements of the platform or vehicle. Movement like roll, pitch, yaw, right, left, port, starboard, altitude gain, altitude decrease, thrust, throttle, gear shift, etc. are done by it.

With that those data from sensors are used to get feedback from the system in close control loop instead of open loop to monitor control and accept the data from system. As well as current system is platform agnostic which makes it able to work with closed loop as well as open loop system. In open loop system, the data is managed by perception/fusion sensor data management and the decision/control/monitoring/management is completed at Remote Control Workstation (RCW).

The vehicle or the tactical platform has a vehicle direct control including vehicle actuators maneuverable under manual control. Vehicle dynamics including speed, inclination etc. impacted by type of vehicle, weight, acceleration capabilities, night vision, turning radii, etc. and such navigational payloads and at the same time impacted by environmental scenario including terrain parameters which are applied to outputs of sensors to give a feedback to Mission Planning.

In the Manual Control mode, any command given by the human operator causing a change detected in throttle or a change in steering is saved in the self-learning module for subsequent autonomous operations. Importantly, although the perception sensors are not actively involved in navigational support in Manual Control, however, the perception sensors continue to generate dataset for self-learning in real time. Even if the vehicle is manually controlled, the perception sensors non-exhaustively collect information about path, surroundings including buildings and distance between them, terrain, drift, atmospheric pressure and build training dataset for use in Mission Planning and Tactical Control situations.

In the Mission Planning mode, the vehicle guidance module generates a path for the vehicle towards completing an assigned task to reach the prescribed destination with respect to a home position, by taking feedback from navigational payloads and perception sensors. The course control module generates commands for vehicle actuators for the assigned task. The perception sensors continue to generate dataset for self-learning in real time with respect to the assigned task, while vehicle guidance model updates dataset in real time.

In the Mission Planning mode with auto maneuvering with situational awareness and tactical control with deliberative collision avoidance, the vehicle guidance module generates a path for the vehicle towards completing an assigned task to reach the prescribed destination with respect to a home position, by taking feedback from navigational payloads and perception sensors. The course control module generates commands for vehicle actuators for the assigned task. The navigation system deploys deliberative payloads like AIS, the environmental scenario and assessment & Correction module for a precision navigation. The navigation system gets the collision related data from the prior information like map data including tree, mountain, building information and terrain information. The perception sensors continue to generate dataset for self-learning in real time with respect to the assigned task, while vehicle guidance model updates dataset in real time.

In the Mission Planning mode with auto maneuvering with situational awareness and tactical control with responsive collision avoidance, the navigation system uses data from cameras, LIDAR, SONAR, ADSB, besides AIS that provide real time data on which the reactive guidance makes course control (through assessment and correction module for collision avoidance. The perception sensors continue to generate dataset for self-learning in real time with respect to the assigned task, while vehicle guidance model updates dataset in real time.

The vehicle having assigned a known destination with respect to a home position calculates its path, which could be more than one. The path prediction is with prescribed preferences and limits based on a cognitive algorithm on a previously trained model from earlier real time dataset. The flight may be with a responsive collision avoidance technique or a deliberative collision avoidance technique.

Importantly, all above embodiments are with availability of a communication network including an internet communication or a satellite communication. The present invention is equally capable in absence of any or all kinds of communication network. The vehicle is assigned a task of reaching an unknown destination which is a drowning person needing help. The unknown destination is hidden behind a big obstruction, which is a ship. In this scenario, navigation is done on the basis of a localized frame of reference, in the form of an imaginary cuboid of situationally prescribed X, Y and Z dimensions created by a deep learning grid algorithm. The X, Y and Z dimensions are situationally prescribed based on a judgement that the home position, the unknown destination and the obstruction are well within the cuboid. The vehicle moves within the cuboid and knows its own relative position with respect to a home position with the help of compass, gyroscope, accelerometer, sonic sensors, cameras and other non-network devices and perception sensors. The vehicle, here a drone, predicts a safe height based on task type, weather condition and Location information inputted.

### DESCRIPTION OF DRAWINGS

FIG. 1 is a representative view of capabilities of the present invention.

FIGS. 2A and 2B is a flow diagram of sub-modules of a navigation system of the present invention.

FIG. 3 gives a segregated tabulation of a remote control workstation of the present invention.

FIG. 4 gives a segmented tabulation of a navigation module of the present invention.

FIG. 5 gives a segmented tabulation of a vehicle or a vehicle platform.

FIG. 6 is a flow diagram of sub-modules of the navigation system pertaining to manual control.

FIG. 7 is a logic diagram of navigational operations in a Manual Control.

FIG. 8 is a representative view of alternative trajectories of the vehicle.

FIGS. 9 and 10 combined is a logic diagram of navigational operations in a Mission planning mode.

FIGS. 9 and 11A-11B combined is a logic diagram of navigational operations in the Mission Planning mode with auto maneuvering with situational awareness and tactical control with deliberative collision avoidance.

FIGS. 9 and 12 combined is a logic diagram of navigational operations in the Mission Planning mode with auto maneuvering with situational awareness and tactical control with responsive collision avoidance.

FIG. 13 is a logic diagram of navigational operation in an illustrative situation.

FIG. 14 is a perspective view of an imaginary cuboid of situationally prescribed X, Y and Z dimensions in situations of absence of communication network.

FIG. 15 is a logic diagram of navigational operation in another illustrative situation.

FIG. 16 is a safe height prediction model in absence of a communication network.

FIG. 17 is a representative view of the vehicle with respect to the imaginary cuboid in a situation.

FIG. 18 is a representative view of another vehicle with respect to the imaginary cuboid in another situation.

FIG. 19 is a flow diagram of self-learning model in presence and in absence of communication network.

FIG. 20 is a simplified line diagram of self-learning model driving a PID controller.

FIG. 21 is illustrative different types of angular controls of an aviation vehicle.

FIG. 22 is an illustrative graph of a predicted and an actual trajectory of a vehicle.

FIG. 23 is a block diagram of hardware of the navigation module of the present invention.

FIG. 24 is a perspective view of the ready to deploy navigation module of the present invention.

### DETAILED DESCRIPTION OF THE INVENTION

The present invention shall now be described with the help of the drawings. The detailed description is a preferred embodiment around which several variation can be developed and therefore it should not be construed to limit the invention in any manner whatsoever.

The present invention is a navigation module, named GENISYS, that is retro-fittable in any manned o unmanned road/aviation/marine/submarine vehicle, and a system thereof. The preferred embodiment is described with the figures of unmanned aviation vehicle, commonly known as drone.

GENISYS and the system around it has the capability to capture all operator instructions and commands including audio, manual, electrical, radio commands and convert them into an executable data/algorithm with time and position co-ordinates.

GENISYS is connected, by hard wiring or wirelessly, with plurality of sensors and intelligence of the vehicle. GENISYS integrates intrinsic capabilities of the vehicle with executable data and algorithms developed from operator instructions and commands.

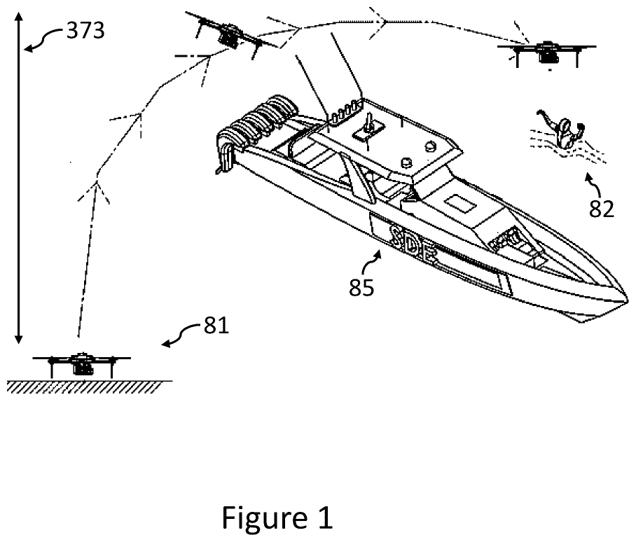

FIG. 1, a drone, hereinafter termed as a platform or a vehicle (302), disposed with a navigation module (100) is capable of self-navigating to an obstructed unknown destination or an obstructed unknown target (82), here a drowning person, even in absence of any communication network. An obstruction (85), here a ship, obstructs a direct view of the target (82). In the description below, the inventive hardware and software of the navigation module (100) is described step by step resulting into such capability.

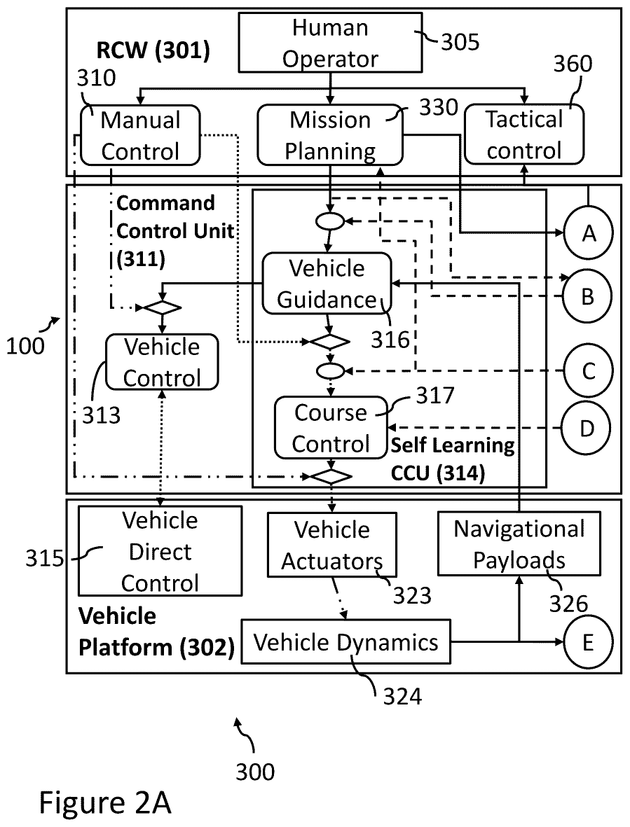

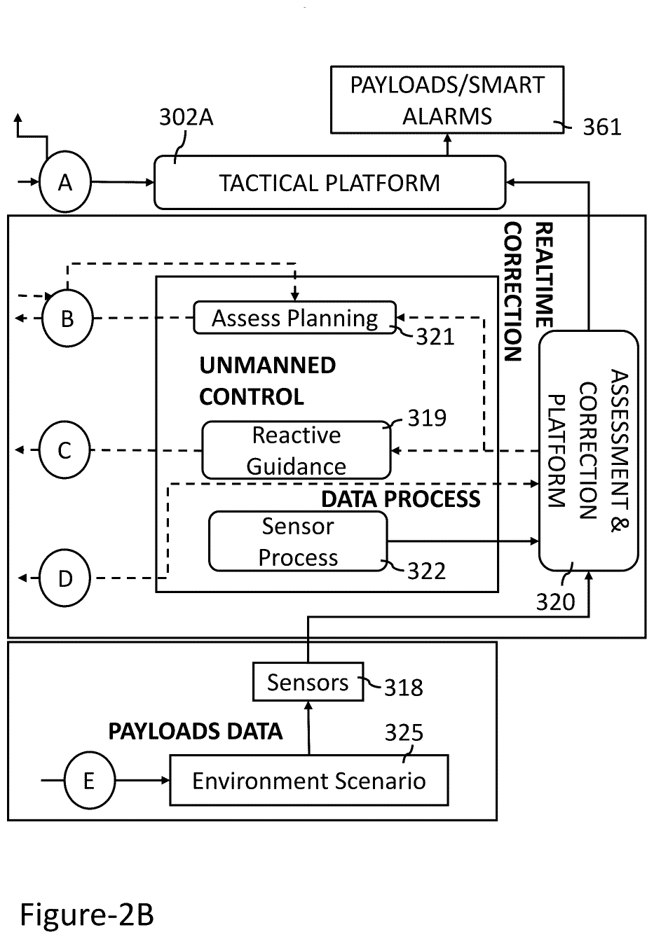

FIG. 2A-2B, a navigation system (300) around a vehicle (302) comprises:
Remote Control Workstation or RCW (301)
Navigation module or GENISYS (100) including Command and Control unit (311) and the Vehicle Platform (302) including a tactical platform (302A)
Perception sensors (318)

The vehicle (302) refers to a platform or a transport system or vehicle that provides a specific capability and effect on an action field. It is essentially a platform or a means of delivering various assets, weapons or equipment to the action space. Such vehicles/tactical platforms (302/302A) vary in size, mobility, function, depending on the operational requirements.

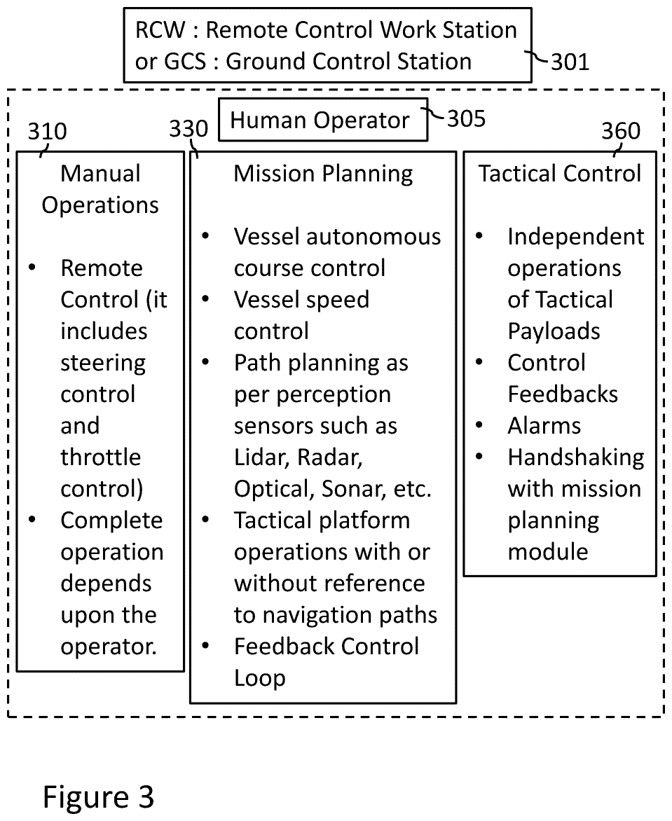

Remote Control Workstation or RCW (301)-RCW (301) or Ground Control Station (GCS) is a section whereby all command-and-control options are initiated, including initial commands and controls by a human Operator (305), responsible for all the operations to be going to be executed on a manual or a semi-autonomous or an autonomous system platform. The command-and-control includes the complete control and monitoring of the system data or system video or payload data or payload control or both. FIG. 3.

Human Operator (305) is a person who is responsible for controlling or monitoring or controlling and monitoring of the system data or system video or payload data or payload control or both. Human Operator (305) performs multiple tasks like Manual Operation (310), Mission Planning (330) and Tactical Control (360) by the Remote Control Workstation (RCW) or the Ground Control Station (GCS) (301).

Three types of controls deployed for the navigation module (100) are
1. Manual Control (310)
2. Mission Planning (330)
3. Tactical Control (360)

Manual control (310) implies direct human control including throttle and steering control, either by being physically present in the tactical platform of vehicle (302) particularly when the vehicle is road worthy vehicle or an airplane or a human carrying drone or a ship or a marine or a submarine; or remotely. Here, the complete operation responsibility is of the human operator (305). The human operator (305) needs to take care of each and every single parameter or setting or state or decision or tactical decision of the system.

In the mission planning (330) type of control, before operation initialization, complete planning is executed. This planning includes how the vehicle should perform, in which scenario how it must behave, and all if-else this that or if commands and controlling factors are preplanned and fed to the RCW system. Once fed, after initialization the vehicle/command control performs functions as configured and RCW would not bypass the planned operations. Mission Planning (330) is the formal definition of any type of unmanned platform or system or vehicle where complete mission or planning or path planning and complete mission preparation and execution is done. Mission Planning (330) and real-time data monitoring/controlling/management is completely integrated into the system or platform. It helps to manage the complete path/plan/mission of the system/platform/vehicle. Data from multiple sensors is taken and graphed or shown or processes or used to generate user interface to perform the multiple jobs like control/monitor/eject/disturb/explode with the help of system/vehicle/platform.

Tactical Control (360)—Tactical control includes wider guidance navigation and controlling system including handshaking with mission planning (330) for decision-making in critical scenarios including scenarios like obstacle avoidance and reactive guidance, including multiple inputs and outputs. Wider guidance navigation contains hardware-software co-related system which determines the desired path of travel called as trajectory from the platform or vehicle's current location to a designated target location. It maps the system with actual trajectory with desired trajectory. The difference is calculated and offset is fed to the system for learning, which helps system to progressively better match the actual trajectory with the desired trajectory.

Generally, divided into two lateral dimensions:
Pitch or pitch angle (88)
Yaw or yaw angle (87), and
Roll or roll angle (86);

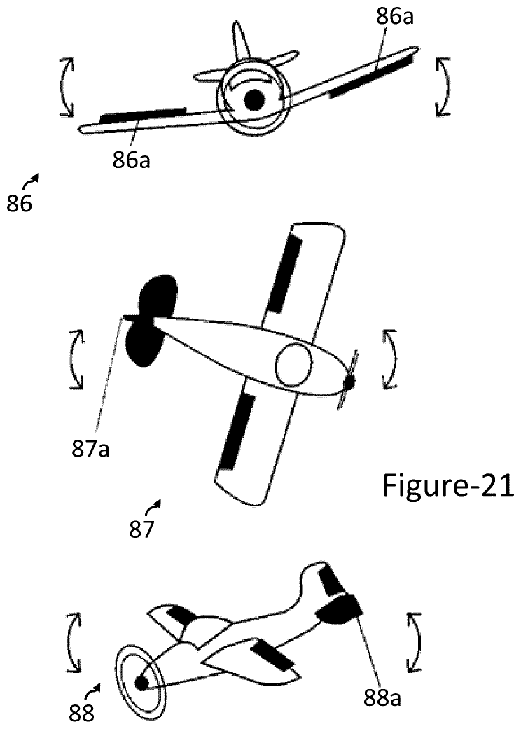

FIG. 21, a movement of aileron (86a) controls the roll (86), a movement of rudder (87a) controls the yaw (87) while a movement of the elevator (88a) controls the pitch (88) of any aviation vehicle. These three channel control outputs are mixed to produce fin commands from angular rate to acceleration feedback. The control strategy is either a proportional-integral (PI) or proportional integral derivative (PID) controller.

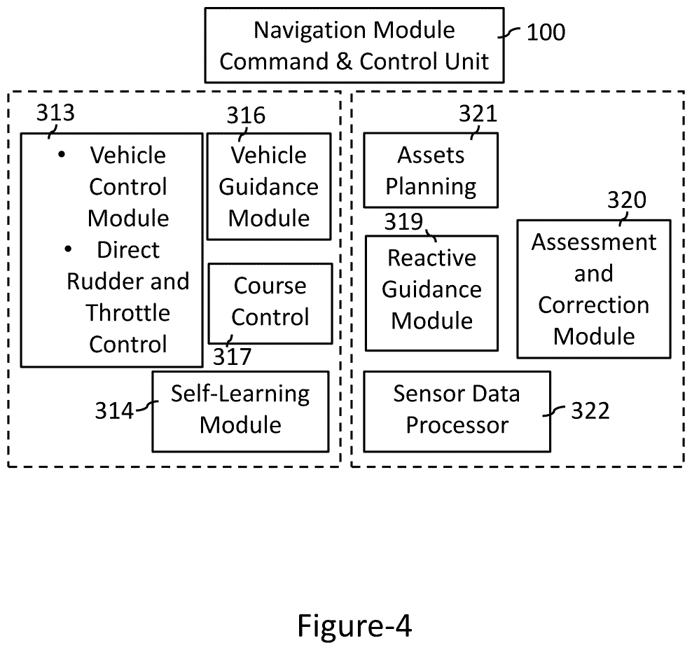

Command Control Unit or CCU (311)-Manual Control (310) works with Command Control Unit (311). Command Control Unit (CCU) comprises Self Learning Command Control Unit (314), Unmanned Control (320) and Assessment & Correction platform (320). Manual Control controls the rudder and throttle of the engine directly without autonomous operation. The vehicle control gives the signal to VDC (Vehicle Direct Control) which manages all the controlling of the vehicle. Here, mixed signal type controlling operators where Command Control Unit processes the data, and it is carried forward to Vehicle Direct Control. FIG. 4.

Self-Learning Command Control Unit (314) consists of the following sub-systems:
Vehicle Guidance (316)
Course Control (317)

Vehicle Guidance system (316) is part of the control structure of the vehicle and consists of a path generator, a motion planning algorithm, and a sensor fusion module. A stereo vision sensor and a GFPS sensor are used as position sensors. The trajectory for the vehicle motion is generated in the first step by using only information from a digital map. Object-detecting sensors such as the stereo vision sensor, three laser scanners, and a radar sensor observe the vehicle environment and report detected objects to the sensor fusion module. This information is used to dynamically update the planned vehicle trajectory to the final vehicle motion. This helps the vehicle guidance system (316) to track correction and complete navigation guidance.

Course control system (317) derives a model for vehicle path-following and course controlling with the management of throttle and heading; wherein the pitch and yaw angles together with the surge velocity can be treated as control inputs.

Unmanned Control (320) primarily relies on a plurality of perception sensors (318) whose data is processed, assessed for precision and provides reactive guidance (319) to mission planning (330).

### Asset Planning (321):

With respect to autonomous maritime platforms, tactical platforms enable to exercise various mission sets such as sea denial, escort, survey, logistics, targeted counter abilities, etc.

As such, such a platform will conduct assets planning by:
Mission Objectives: The tactical platform starts by defining the mission objectives based on the requirements or tasks to be accomplished. These objectives can include patrolling a specific area, conducting search and rescue operations, monitoring maritime traffic, or any other mission-specific goals.
Data Collection and Analysis: The platform collects relevant data from various sources to gain situational awareness. This data can include real-time information on weather conditions, vessel traffic, sensor readings, geographical features, and mission constraints. The platform analyzes this data to understand the current operational environment and identify potential risks or opportunities.
Asset Availability and Capabilities: The platform assesses the availability and capabilities of the assets at its disposal. This includes considering the types of autonomous sea-going vessels, their sensor suites, communication systems, endurance, speed, and any other relevant characteristics. The platform also takes into account the operational constraints and limitations of each asset.
Optimization Algorithms: The tactical platform utilizes optimization algorithms to determine the most effective deployment and utilization of assets. These algorithms consider factors such as asset capabilities, mission objectives, constraints, and operational parameters to generate optimized plans. The plans may include routes, schedules, task assignments, and coordination strategies.
Resource Allocation: Based on the optimized plans, the tactical platform assigns tasks and allocates resources to the autonomous sea-going vessels. It ensures that the assets are efficiently distributed to maximize coverage, minimize response times, and optimize the overall mission performance. This may involve considering factors such as asset proximity to target areas, their current status, and their suitability for specific tasks.
Dynamic Adaptation: The tactical platform continuously monitors the operational environment and adapts the assets planning as needed. It can dynamically adjust plans in response to changing conditions, emerging threats, or new mission requirements. This adaptability allows the platform to optimize the allocation of assets in real-time and make informed decisions based on the latest information.
Communication and Coordination: The tactical platform facilitates communication and coordination among the autonomous sea-going vessels and other entities involved in the mission. It establishes communication links, provides real-time updates, and enables collaboration between the assets. This ensures that the assets are synchronized, share relevant information, and work together to achieve the mission objectives effectively.

By combining data analysis, optimization algorithms, and adaptive planning strategies, an autonomous maritime tactical platform can efficiently conduct assets planning for autonomous sea-going vessels. It optimizes the utilization of assets, enhances mission performance, and enables effective decision-making in dynamic maritime environments.

### Assessment and Correction Platform (320):

Based on its perception and awareness of the environment, the given tasks/objectives, the onboard payloads, the platform continuously assesses the objectives, the effects achieved, and whether or not corrections are needed in its execution. Thereafter corrective measures are implemented and action taken to ensure that the tactical platform fulfills its objectives.

The plurality of perception sensors (318) connected to the reactive guidance system (319) include:
Accelerometer
Gyroscope
Compass
Magnetic Heading Sensor
Barometric Sensor
Multiple GNSS
Vision Sensor including camera, stereo camera, Omni camera, IR camera
Ultra-sonic sensor
Laser Range finder
Li-Dar, Sonar, Radar
Optical sensor
GNSS sensor
Depth sensor

Such type of sensor data using sensor fusion algorithms gives appropriate data. It is referred to as a computational methodology that aims at combining measurement from multiple sensors such that they jointly give more precise information on the measured system than any of the sensors alone.

The data from such sensor and data from human operator or third-party user or device helps to perform the critical tasks at Remote Control Workstation (RCW) with human operator in-loop. This data is used to course controlling of the platform or vehicle (302). Course control includes multiple movements of the platform or vehicle (302). Movement like roll, pitch, yaw, right, left, port, starboard, altitude gain, altitude decrease, thrust, throttle, gear shift, etc. are done by it.

With that those data from sensors are used to get feedback from the system in close control loop instead of open loop to monitor control and accept the data from system. As well as current system is platform agnostic which makes it able to work with closed loop as well as open loop system. In open loop system, the data is managed by perception/fusion sensor data management and the decision/control/monitoring/management is completed at Remote Control Workstation (RCW).

The self-learning command control unit (314) comprises multiple FRAM and NVRAM memory storage which store the main control code which resides in the directory of the boot controller.

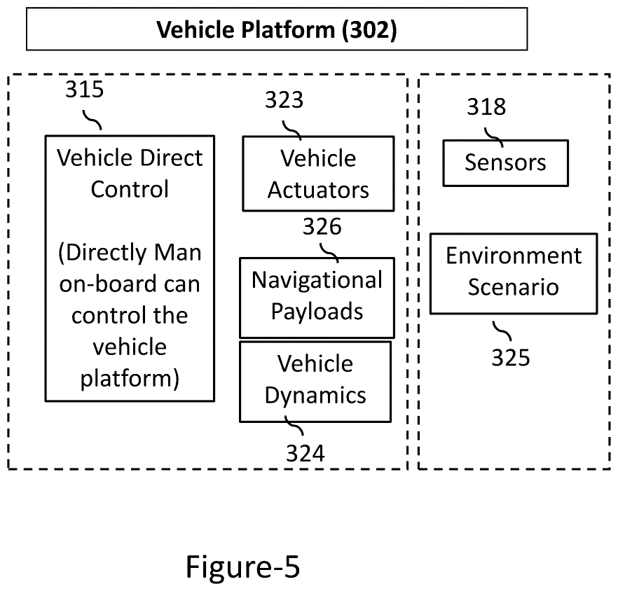

FIG. 5, the vehicle (302) or the tactical platform (302A) has a vehicle direct control (315) including vehicle actuators (323) maneuverable under manual control (310). Vehicle dynamics (324) including speed, inclination etc. impacted by type of vehicle, weight, acceleration capabilities, night vision, turning radii, etc. and such navigational payloads (326) and, at the same time impacted by environmental scenario/constraints (325) including terrain parameters which are applied to outputs of sensors (318) to give a feedback to Mission Planning (330).

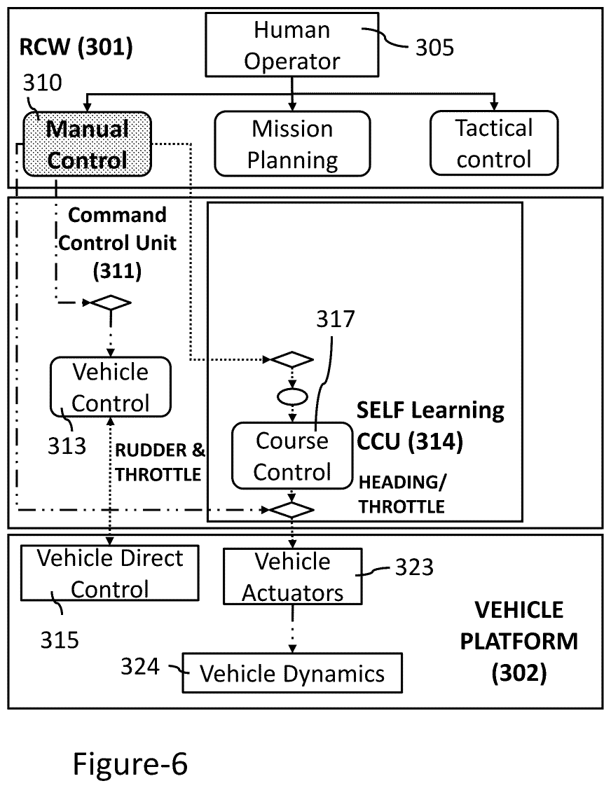

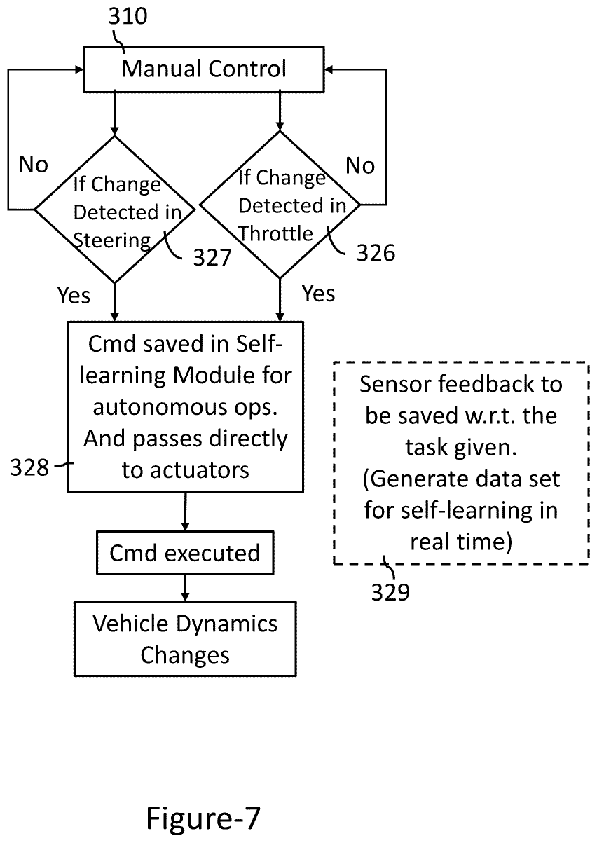

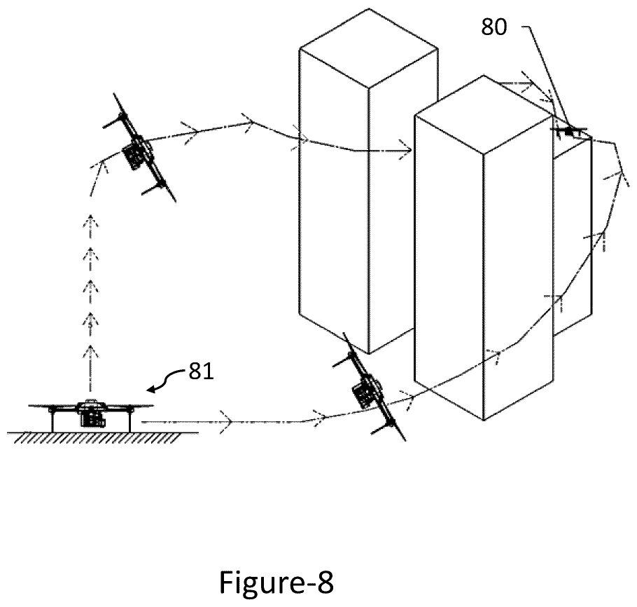

FIG. 6, 7, in the Manual Control mode (310), any command given by the human operator causing a change detected in throttle (326) or a change in steering (327) is saved in the self-learning module (328) for subsequent autonomous operations. Importantly, although the perception sensors are not actively involved in navigational support in Manual Control (310), however, the perception sensors continue to generate dataset for self-learning in real time (329). Illustratively, FIG. 8, even if the vehicle (302) is manually controlled, the perception sensors non-exhaustively collect information about path, surroundings including buildings (151) and distance between them (152), terrain, drift, atmospheric pressure and build training dataset for use in Mission Planning (330) and Tactical Control (360) situations.

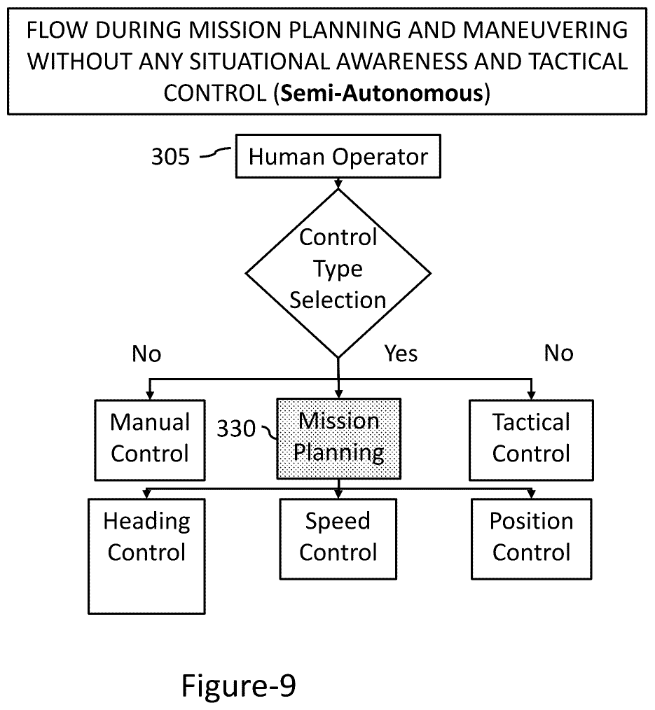

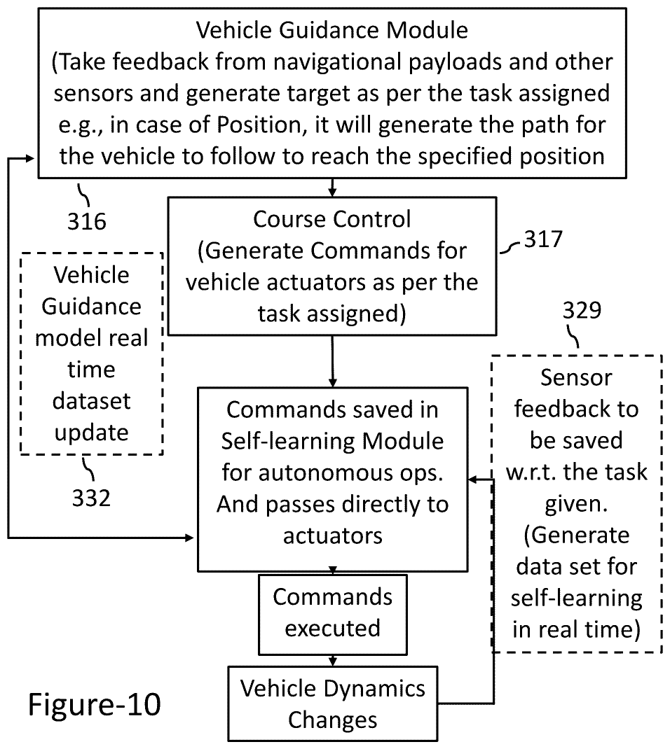

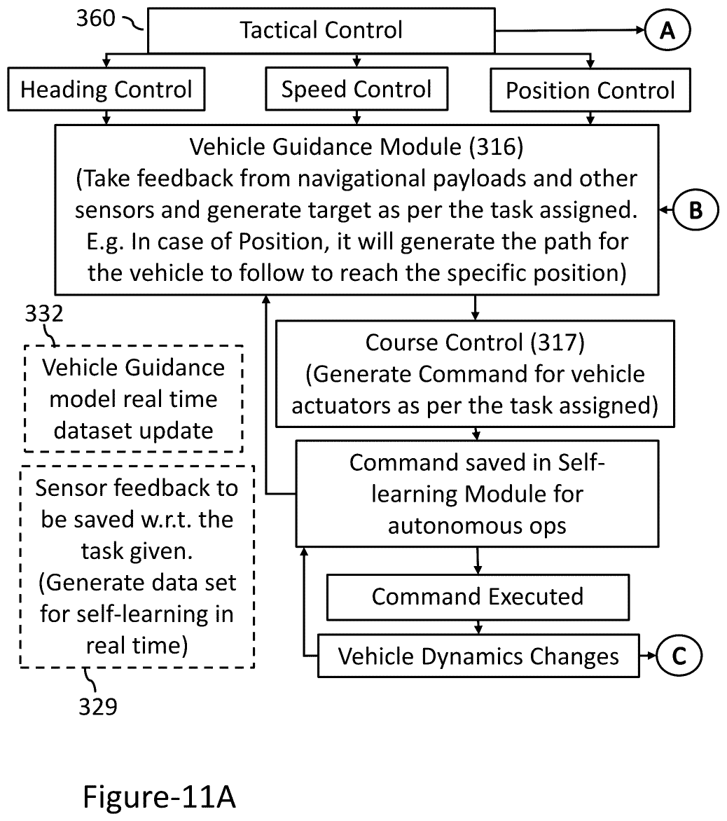

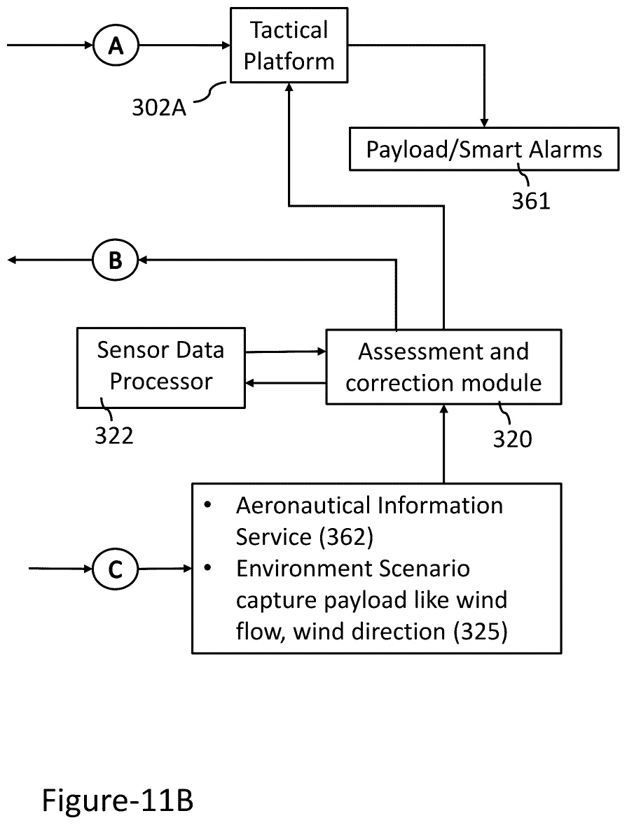

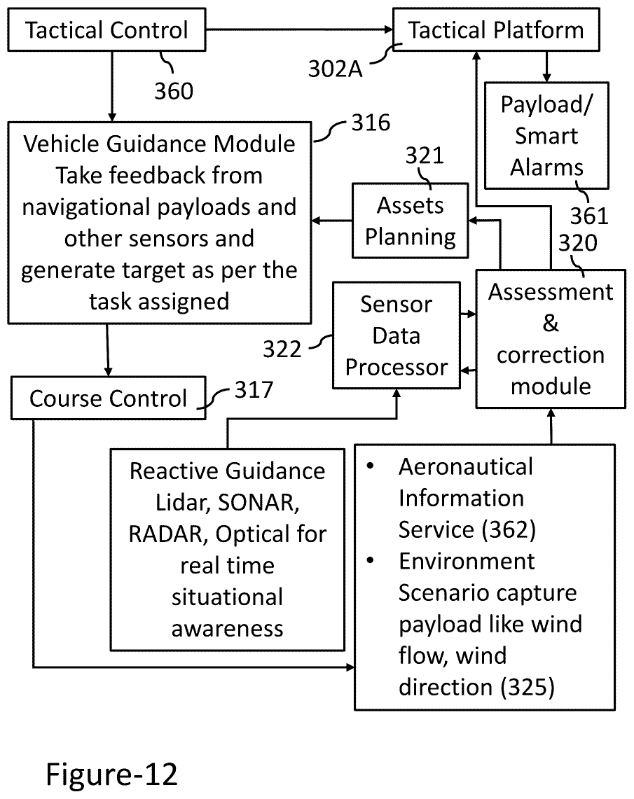

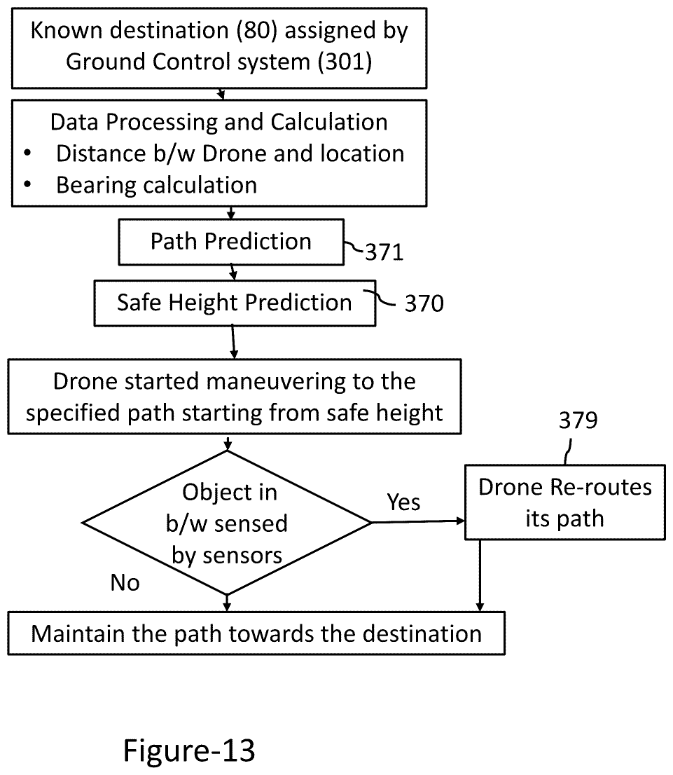

FIG. 9, 10, in the Mission Planning mode (330) which is a semi-autonomous mode, the vehicle guidance module (316) generates a path for the vehicle (302) towards completing an assigned task to reach the prescribed destination with respect to a home position, by taking feedback from navigational payloads (326) and perception sensors (318). The course control module (317) generates commands for vehicle actuators (323) for the assigned task. The perception sensors (318) continue to generate dataset for self-learning in real time (329) with respect to the assigned task, while vehicle guidance model updates dataset in real time (332).

FIG. 9, 11A-11B, in the Mission Planning mode (330) with auto maneuvering with situational awareness and tactical control with deliberative collision avoidance, the tactical platform (302A) is equipped with payloads/smart alarms (361). The vehicle guidance module (316) generates a path for the vehicle (302) towards completing an assigned task to reach the prescribed destination with respect to a home position, by taking feedback from navigational payloads (326) and perception sensors (318). The course control module (317) generates commands for vehicle actuators (323) for the assigned task. The navigation system (100) deploys deliberative payloads like aeronautical information services or AIS (362), the environmental scenario/constraints (325) and assessment & Correction module (320) for a precision navigation. The navigation system (100) gets the collision related data from the prior information like map data including tree, mountain, building information and terrain information. The perception sensors (318) continue to generate dataset for self-learning in real time (329) with respect to the assigned task, while vehicle guidance model updates dataset in real time (332).

FIG. 9, 12, in the Mission Planning mode (330) with auto maneuvering with situational awareness and tactical control with responsive collision avoidance, the vehicle guidance module (316) generates a path for the vehicle (302) towards completing an assigned task to reach the prescribed destination with respect to a home position, by taking feedback from navigational payloads (326) and perception sensors (318). The course control module (317) generates commands for vehicle actuators (323) for the assigned task. The navigation system (300) deploys deliberative payloads like AIS (362), the environmental scenario/constraints (325) and assessment & Correction module (320) for a precision navigation. The navigation system (300) uses data from cameras, LIDAR, SONAR, ADSB, besides aeronautical information services (AIS) that provide real time data on which the reactive guidance (319) makes course control (through assessment and correction module (320) for collision avoidance. The perception sensors (318) continue to generate dataset for self-learning in real time (329) with respect to the assigned task, while vehicle guidance model updates dataset in real time (332).

FIG. 9,13, the vehicle (302) having assigned a known destination (80) with respect to a home position (81) calculates its path, which could be more than one. A safe height prediction (370) and a path prediction (371) is with prescribed preferences and limits based on a cognitive algorithm on a previously trained model from earlier real time dataset. In the event any object is detected enroute, the vehicle (302) re-routes the path (379) in a prescribed order. The flight may be with a responsive collision avoidance technique or a deliberative collision avoidance technique.

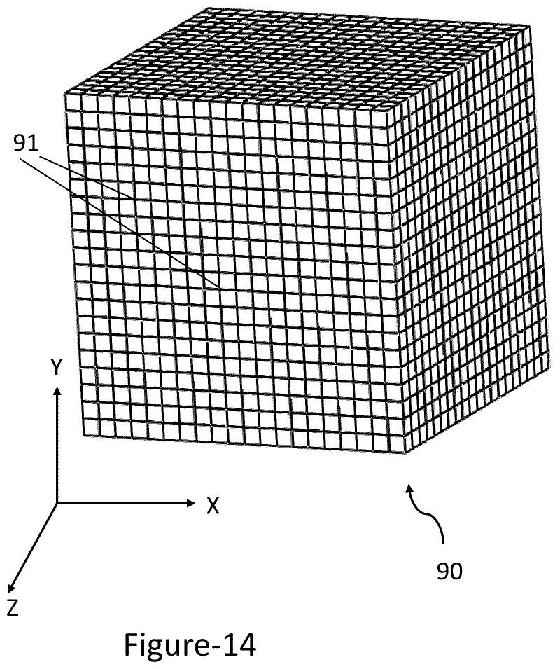

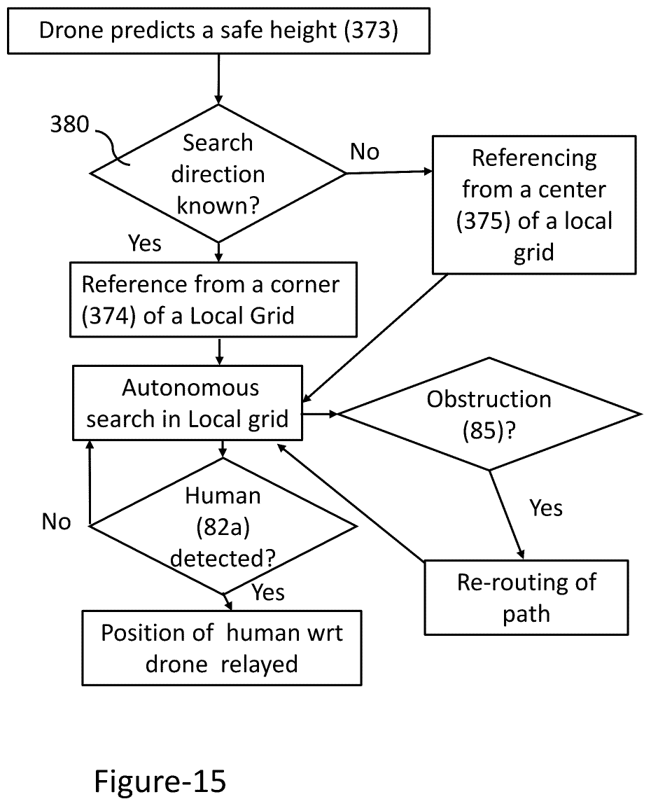

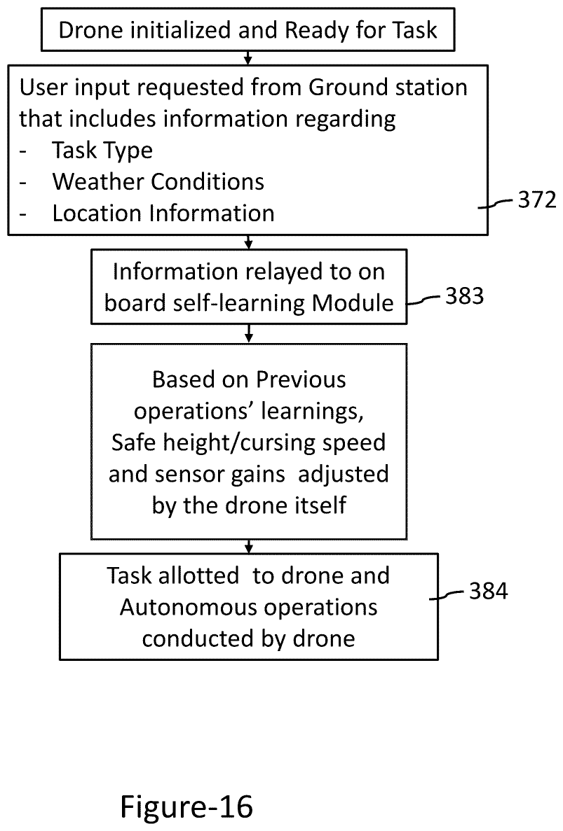

Importantly, all above embodiments are with availability of a communication network (390) including an internet communication or a satellite communication. The present invention is equally capable in absence of any or all kinds of communication network (390). FIG. 1, the vehicle (302) is assigned a task of reaching an unknown destination (82) which is a drowning human (82a) needing help. The unknown destination (82) is hidden behind a big obstruction (85), which is a ship. In this scenario, navigation is done on the basis of a localized frame of reference, in the form of an imaginary cuboid (90) of situationally prescribed X, Y and Z dimensions created by a deep learning grid algorithm. FIG. 14. The cuboid (90) comprises a precision three-dimensional grid creating a plurality of nodes (91) by intersections of X, Y and or Z co-ordinates. The vehicle (302), while moving in the cuboid (90) knows its precise position by the corresponding node(s) (91). The X, Y and Z dimensions are situationally prescribed based on a judgement such that the home position (81), the unknown destination (82) and the obstruction (85) are well within the cuboid (90). The vehicle moves within the cuboid (90) and knows its own relative position with respect to the home position (81) with the help of compass, gyroscope, accelerometer, sonic sensors, cameras and other non-network devices and perception sensors (318). FIG. 1, 15, 16, the vehicle (302), here a drone, predicts a safe height (373) based on task type, weather condition and location information (372) inputted manually. Such information is relay to the self-learning module (383) of the navigation module (100). Based on previous operations' learning Safe height/cursing speed and sensor gains adjusted by the drone itself, the drone completes the task autonomously (384).

The grid is a deep learning algorithm based which configures grid of coarser or finer pitch based on a prescribed task. Illustratively, to locate a human, the grid would be of a pitch of a feet, while the grid would be of far longer pitch when the destination is a ship or a building.

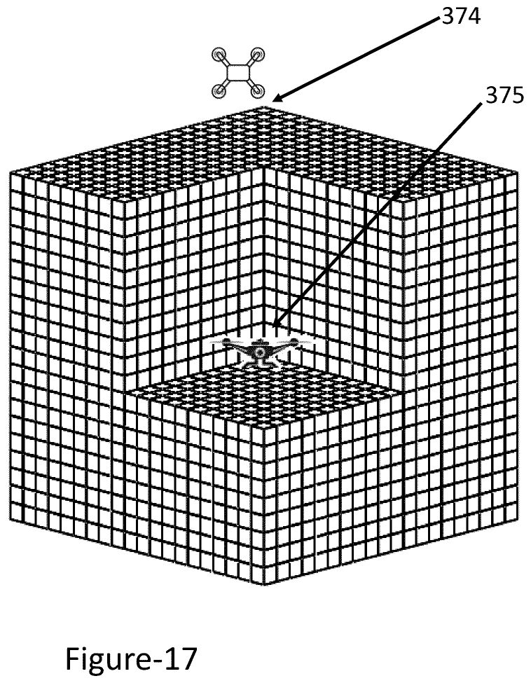

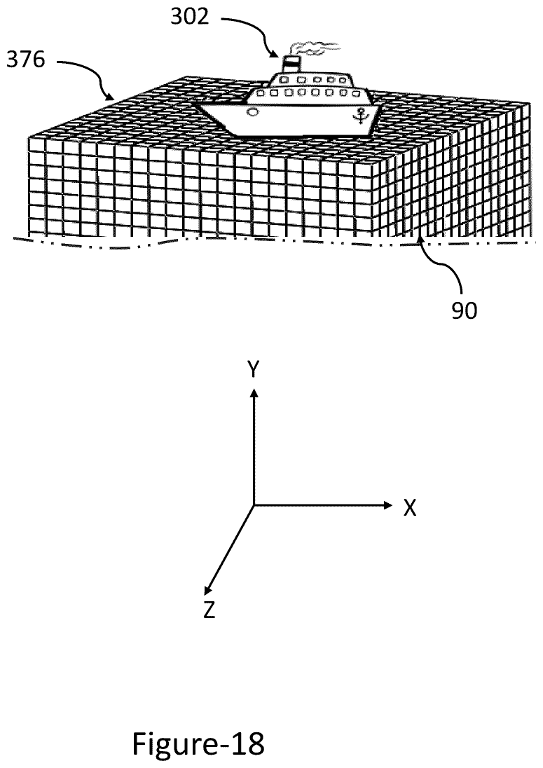

Search direction (380)—The home position (81) is in the center (375) of the cuboid (90) when search direction is unascertained, or the home position is a corner (374) of the cuboid (90) if the search direction is ascertained. FIG. 17. The home position (81) is on a top edge (376) of the cuboid (90) when the vehicle (302) is a marine vehicle, FIG. 18.

As a variation, the imaginary cuboid (90) is an electromagnetic field, or any other energy field locally generated by the vehicle (302) or the tactical platform (302A) around itself. The imaginary cuboid (90) thus effectively navigates the vehicle (302) or the tactical platform (302A) particularly with the aid of the sensor fusion algorithm based self-learning module (314) prudently ensuring precision and redundancy. As earlier mentioned, the sensor fusion algorithm is a computational methodology deployed to analyze and compare relatable sensor data for mismatch and use a “fused” data for training the AI model (377) instead of merely using the captured data.

Relatable data illustratively implies comparing a linear measure from more than one sensor directly or indirectly. Thus, a plurality of orthogonal linear measure would be applied with geometrical rules to compute a non-orthogonal measure.

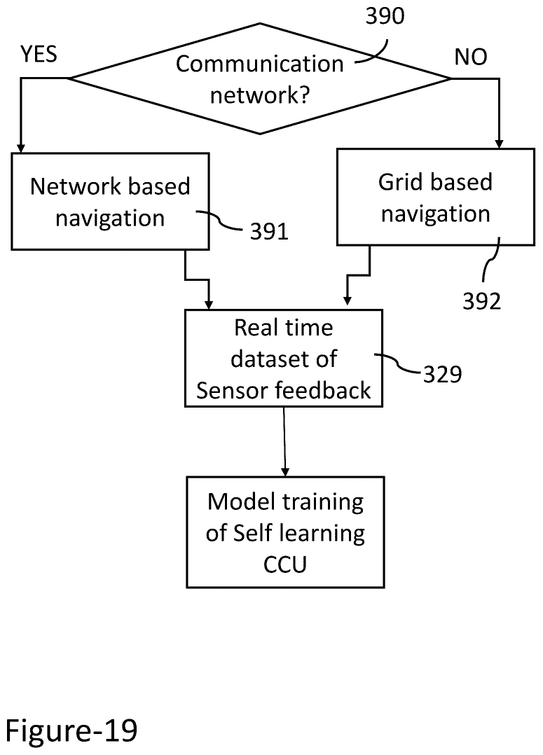

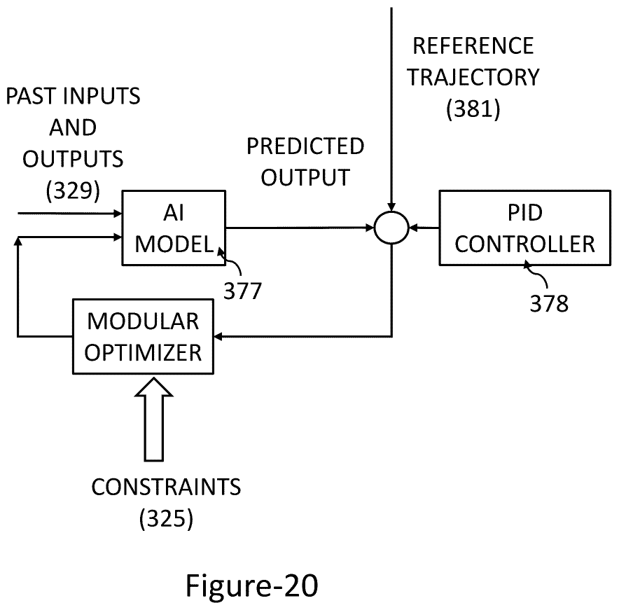

It is known that stand-alone electromechanical non-network based sensors are generally less accurate and the vehicle (302) takes a regular feedback from the previously trained cognitive navigation algorithm-based AI model (377). FIG. 19, the navigation switches between network based navigation (391) to grid based navigation (392) with an intermittent communication network availability, in order to continuously course correct a trajectory till the assigned task is accomplished.

Algorithms and computer programs present in multiple layers are present in the working of the self-learning command control unit (314), notably:
User Interface
Intra-Communication Layer
Multiple Vehicle Libraries.
Here those libraries decide the behavior of the control system as per the vehicle which can be Ground Vehicle, UAV, USV, AUV, etc.
Vehicle Specific Code
Control and Thread Management Layer.
Hardware
Sensory System or Payload
Sensors
Payload Control
Sandbox Layer for control

### User Interface:

User Interface is the interaction medium of human operator to the system. All the control and monitoring parameters and control analogy is available on the User Interface of the system.

### Intra-Communication Layer:

Intra-communication layer is the layer where communication between a computing system and multiple payloads like sensory system, Input Channel, Output Channels is gets managed. The most important part of this layer is to make sure that if one channel of communication medium is getting affected then in that case to manage and initiate the communication using another communication channel including switching navigation from one communication network (390) to another communication network (390). Thus, all monitoring and controlling is done through this layer.

### Multiple Vehicle Libraries:

All the threading related multiple vehicle operation control is managed by these libraries. These libraries enable hardware able to understand type of vehicle a specific hardware and corresponding software is going to control. For example, if car is going to be controlled from a specific hardware in that case the control and Thread Management layer will use the car type of vehicle libraries from the set of data, so that software and hardware can understand that which types of commands will be required for that specific vehicle.

### Control and Thread Management Layer:

This layer enables the processor to control the clock and timing of the complete system so that the multiple threading/multiple processes can work synchronously.

### Hardware:

In this layer hardware is assigned. For example, initialization of software drivers, DLLs required for specific hardware peripherals so that compatibility issue can be resolved.

### Sensory System and Payload:

The payload and navigation sensors like accelerometers, vision system, compass/heading sensor, gyroscope, camera system, etc. are assigned in this system.

### Sand Box Layer for Control and Testing:

It is isolated testing environment that enables users to run and decides the program for which the controlling can be done without affecting the application and system or platform that we run.

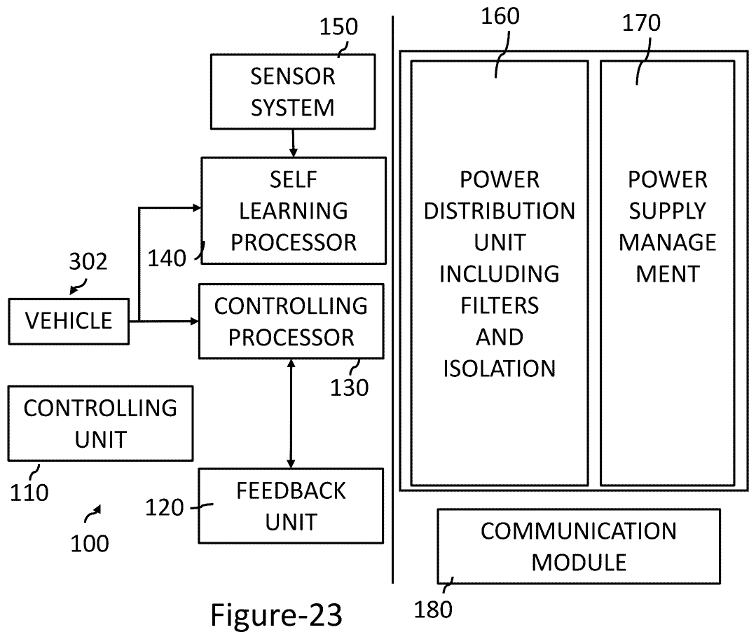

FIG. 23, 24, the navigation module (100) consists of following core hardware components:
Controlling Unit (110)
Feedback Unit (120)
Controlling Processor (130)
Self-Learning Processor (140)—The self-learning processor (140) receives the dataset for training and comprises a model with cognitive navigation algorithms including sub-routines as per embodiment
Sensor System (150)—The sensor system (150) receives inputs from the perception sensors (318) and converts all inputs suitable for PID controlling of vehicle actuators (323)
Power Distribution unit including filters and isolation (160)
Power Supply Management (170)
Communication Module (180)

The navigation system (300) deploying the navigation module (100) with the aid of a plurality of perception sensors (318) controls the tactical platform or vehicle (302) with micro-management, wherein all operator instructions and commands including audio, manual, electrical, radio commands are captured by a navigation algorithm with deep learning based Command & Control Unit.

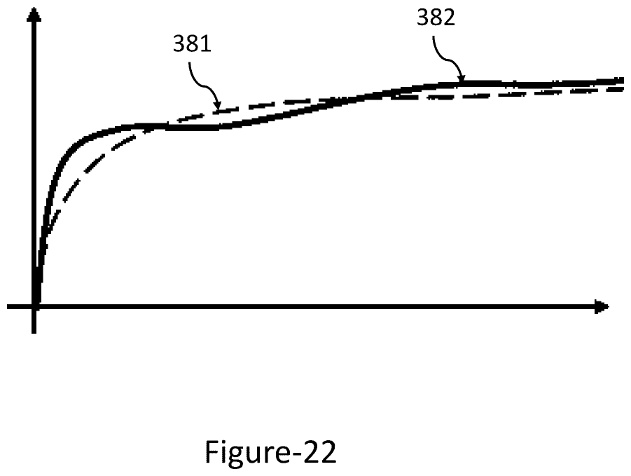

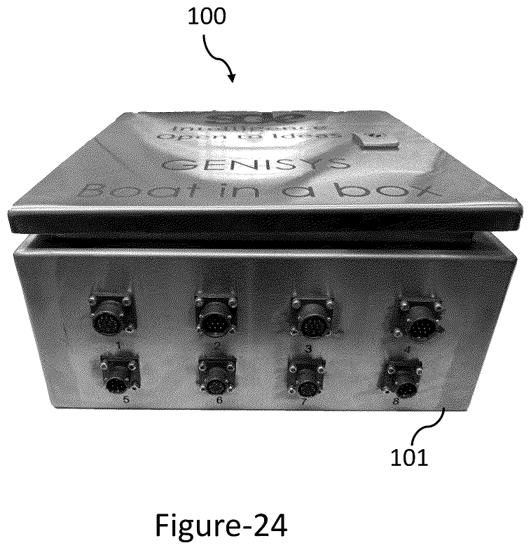

All previously recorded position and relative time information is retrieved and compared against position and relative time information occurring during automatic maneuver. The difference between the previously recorded information and the actual information is used to generate error signals which are converted to command signals as well as to learn/self-learn. FIG. 22, the essence of the present invention is a closeness between a predicted trajectory (381) and an actual trajectory (382), as an outcome of continuous real time learning, sending training dataset to model execution navigational algorithm. Self-Learning command and control system as per the present invention works closely with a human operator by utilizing levels of “managed autonomy”. This allows the operator to focus on the work at hand rather than directly navigating the vehicle. The technological advantage includes the hybrid technology with smart algorithm hardware for both manned & unmanned operations. This can be configured to suit the particular vehicle & is not restricted to vehicle type. The technology is equally suited to controlling torpedo shaped vehicles & also high-speed vehicles. It uses self-tuning algorithms, which it learns from the vehicle responses & adapts itself to it. It can be used as a simple autopilot to a high end stand-alone unmanned system. The technology s utilized in survey, security & military applications. The self-learning command and control system is modular and application adaptive, therefore aptly named navigation module (100) & thus can be retro-fitted easily onto any vehicle irrespective of its type, size, shape, application & propulsion. FIG. 24 is an image of a navigation module (100) in deployment. A rugged, vibration resistant, moisture and ingress proof enclosure (101) houses robust electronics.

We claim:

1. A navigation system (300) for a land, air, marine or submarine vehicle (302), the vehicle (302) comprising a manual control and a plurality of vehicle actuators; characterized by:
An RCW (remote control workstation) (301) with a Manual control mode (310), a Mission Planning mode (330) and a tactical control mode (360) initiating command-and-control options including initial and interventional commands and controls by a human Operator (305),
A navigation module (100) comprising a command Control unit (311) with a self-learning command control module (314),
A plurality of perception sensors (318) disposed on the vehicle (302),
the navigation system (300) receives manual, electrical, radio and audio commands of the human operator (305) in the manual control mode (310) and mission planning mode (330) and converts them to dataset for training a navigation model having a navigational algorithm residing in the self-learning command control module (314),
the plurality of perception sensors (318) generates a dataset for self-learning in real time in the manual control mode (310), the mission control mode (330) and the tactical control mode (360), and
the navigational system (300) autonomously navigates with presence of communication network (390) as well as in absence of any communication network (390).

2. The navigation system (300) as claimed in claim 1, wherein the navigation module (100) further comprises:
a Controlling Unit (110),
a Feedback Unit (120),
a Controlling Processor (130),
a Self-Learning Processor (140),
a Sensor System (150),
a Power Distribution unit including filters and isolation (160),
a Power Supply Management (170), and
a Communication Module (180),
a plurality of perception sensors (318) connected to the sensor system (150) through a hard wiring or wirelessly through the communication module (180), the sensor system (150) receives inputs from the perception sensors (318) and converts all inputs suitable for a proportional integral derivative (PID) controller (378) for a vehicle actuators (323), the self-learning processor (140) receives a training dataset for a cognitive navigation algorithm model.

3. The navigation system (300) as claimed in claim 1, wherein the Mission Planning mode (330) is executed before an operation initialization, the dataset from the plurality of perception sensors (318) is taken and graphed or shown or processed or used to generate user interface to perform a multiple jobs including control/monitor/eject/disturb/explode with the help of system/vehicle/platform.

4. The navigation system (300) as claimed in claim 1, wherein the tactical Control (360) includes handshaking with mission planning (330) for decision-making in critical scenarios including obstacle avoidance and reactive guidance, determines the desired path of travel or trajectory from the platform or vehicle's current location to a designated target location, maps the system with actual trajectory with desired trajectory, the difference is calculated and offset is fed to the system for learning, to progressively better match the actual trajectory (382) with the desired trajectory (381).

5. The navigation system (300) as claimed in claim 1, wherein the Mission Planning mode (330) conducts auto maneuvering with situational awareness and tactical control with deliberative collision avoidance, the vehicle guidance module (316) generates a path for the vehicle (302) towards completing an assigned task to reach the prescribed destination with respect to a home position, the navigation system (300) gets a collision related data from a prior information set of map data including tree, mountain, building information and terrain information, the perception sensors (318) continue to generate dataset for self-learning in real time (329) with respect to the assigned task, while vehicle guidance model updates dataset in real time (332).

6. The navigation system (300) as claimed in claim 1, wherein the Mission Planning mode (330) conducts auto maneuvering with situational awareness and tactical control with responsive collision avoidance, the vehicle guidance module (316) generates a path for the vehicle (302) towards completing an assigned task to reach the prescribed destination with respect to a home position, the course control module (317) generates commands for vehicle actuators (323) for the assigned task, the navigation system (300) uses data from cameras, LIDAR, SONAR, ADSB, besides aeronautical information services, that provide real time data on which the reactive guidance (319) makes course control through assessment and correction module (320) for collision avoidance, the perception sensors (318) continue to generate dataset for self-learning in real time (329) with respect to the assigned task, while vehicle guidance model updates dataset in real time (332).

7. The navigation system (300) as claimed in claim 1, wherein the Command Control Unit or CCU (311) comprises a Self-Learning Command Control Unit (314), Unmanned Control (320) and Assessment & Correction platform (320), the Self-Learning Command Control Unit (314) consists of:
Vehicle Guidance (316), wherein Vehicle Guidance system (316) has a path generator, a motion planning algorithm, and a sensor fusion module, a stereo vision sensor and a GFPS sensor are used as position sensors, a trajectory for the vehicle motion is generated in the first step by using only information from a digital map while object-detecting sensors such as the stereo vision sensor, three laser scanners, and a radar sensor observe the vehicle environment and report detected objects to the sensor fusion module, dynamically updates the planned vehicle trajectory to the final vehicle motion to track correction and complete navigation guidance, and
Course Control (317), wherein the Course control system (317) derives a model for vehicle path-following and course controlling with the management of throttle and heading; wherein a pitch angle (88), a roll angle (86), a yaw angle (87), and a surge velocity are inputs.

8. The navigation system (300) as claimed in claim 1, wherein the tactical control (360) in handshaking with the mission planning (330) conducts asset planning (321) with respect to mission objectives by optimization algorithms for resource allocation and dynamic adaptation in response to changing conditions, emerging threats, or new mission requirements in real-time and facilitates communication and coordination among other entities involved in the mission to ensure synchronization.

9. The navigation system (300) as claimed in claim 8, wherein an assessment and correction Platform (320) continuously assesses the objectives, the effects achieved, and corrections needed in its execution, implements a corrective measures and actions taken.

10. The navigation system (300) as claimed in claim 1, wherein the plurality of perception sensors (318) connected to the reactive guidance system (319) include Accelerometer, Gyroscope, Compass, Magnetic Heading Sensor, Barometric Sensor, Multiple GNSS, Vision Sensors, sonic sensor, Laser Range finder, Li-Dar, Sonar, Radar, Optical sensor, depth sensor, and wherein a sensor data is fused using a plurality of sensor fusion algorithms.

11. The navigation system (300) as claimed in claim 1, wherein the vehicle (302) having assigned a known destination (80) with respect to a home position (81) generates a plurality of path prediction (371) with prescribed preferences and limits based on a cognitive navigation algorithm on a previously trained navigation model from earlier real time dataset.

12. The navigation system (300) as claimed in claim 1, wherein the navigation module (100), in absence of a communication network (390) carries out navigation via a localized frame of reference in the form of an imaginary cuboid (90) of situationally prescribed X, Y and Z dimensions created by a deep learning grid algorithm, the X, Y and Z dimensions are situationally prescribed based on a judgement that the home position (81), the unknown destination (82) and the obstruction (85) are well within the cuboid (90), the vehicle moves within the cuboid (90) and knows its own relative position with respect to a home position (81) with the help of a plurality of electromechanical non-network based sensors including compass, gyroscope, accelerometer, sonic sensors, cameras and other non-network devices and perception sensors (318).

13. The navigation system (300) as claimed in claim 1, wherein the navigation module (100) of the vehicle (302), here a drone, predicts a safe height (373) based on task type, weather condition and Location information (372) inputted manually.

14. The navigation system (300) as claimed in claim 12, wherein the imaginary cuboid (90) is an electromagnetic field locally generated by the vehicle (302) or the tactical platform (302A) around itself.

15. The navigation system (300) as claimed in claim 12, wherein the imaginary cuboid (90) is an energy field locally generated by the vehicle (302) or the tactical platform (302A) around itself.

16. The navigation system (300) as claimed in claim 12, wherein the imaginary cuboid (90) comprises a precision three-dimensional grid creating a plurality of nodes (91) by intersections of X, Y and or Z co-ordinates.

17. The navigation system (300) as claimed in claim 12, wherein a home position (81) is a center (375) of the cuboid (90) when search direction is unascertained, or the home position (81) is a corner (374) of the cuboid (90) if the search direction is ascertained.

18. The navigation system (300) as claimed in claim 12, wherein a home position (81) is a top edge (376) of the cuboid (90) when the vehicle (302) is a marine vehicle.

19. The navigation system (300) as claimed in claim 12, wherein the vehicle guidance system (316) of the vehicle (302) takes a regular feedback from a previously trained cognitive navigation algorithm based AI navigation model (377).

20. The navigation system (300) as claimed in claim 12, wherein the navigation switches between a network based navigation (391) to a grid based navigation (392) with intermittent network availability, in order to continuously course correct a trajectory.

21. The navigation system (300) as claimed in claim 1, wherein the navigation system (300) comprises an intra-communication layer computer program for switching navigation from one communication network (390) to another communication network (390).

22. The navigation system (300) as claimed in claim 1, wherein the navigation system (300) comprises multiple vehicle libraries for selecting appropriate vehicle control and vehicle guidance commensurate with land, air, marine or submarine vehicle navigation.

23. The navigation system (300) as claimed in claim 1, wherein the navigation system (300) comprises Control and Thread Management Layer computer program to synchronize and control the clock and timing of multiple threading/multiple processes.

24. The navigation system (300) as claimed in claim 1, wherein the navigation system (300) comprises a Sand Box Layer for control and testing in an isolated testing environment.

25. The navigation system (300) as claimed in claim 1, wherein the navigation module (100) is retrofittably disposed on the vehicle (302).

26. The navigation system (300) as claimed in claim 1, wherein the dataset is a “fused” dataset based on the sensor fusion algorithm.
